(19) United States
(12) Patent Application Publication
(10) Pub. No.: US 2019/0133274 A1
(43) Pub. Date: May 9, 2019

(54) INJECTION-MOLDED CASES AND METHOD OF THEIR MANUFACTURE

(71) Applicant: TRAVEL SMART LTD, Herzliya OT (IL)

(72) Inventors: Efraim HAIMOFF, Mevaseret Zion (IL); Sami SAGOL, Ramat Hasharon (IL)

(73) Assignee: TRAVEL SMART LTD, Herzliya, OT (IL)

(21) Appl. No.: 16/076,160

(22) PCT Filed: Feb. 9, 2017
(86) PCT No.: PCT/IL2017/050166

§ 371 Date: Aug. 7, 2018

(30) Foreign Application Priority Data
Feb. 11, 2016 (GB) 1602472.1

(51) Int. Cl. A45C 5/03; A45C 5/14; B29C 45/00

(52) U.S. Cl. CPC A45C 5/03; A45C 2005/037; B29C 45/0046; A45C 5/14

(57) ABSTRACT

Provided is an injection-molded case and a method of manufacturing the same. The case in accordance with the disclosed subject matter includes at least one shell formed by injection molding of a plastic material. The at least one shell has a base panel and a wall circumferentially extending therefrom and the wall having an edge defining a perimeter of the shell. The at least one shell being substantially rigid and further including a rigid structural component and wherein the perimeter being fitted with flexible fastener integrally molded at least over portions of said perimeter, the fastener configured to fasten the at least one shell to a complementary cover member so as to define an enclosed space therebetween.

### TECHNOLOGICAL FIELD

The present disclosure is directed to cases and methods of manufacturing thereof; in particular, to an injection-molded cases, such as luggage cases.

### BACKGROUND ART

References considered to be relevant as background to the presently disclosed subject matter are listed below:
[1] EP1150587
[2] EP2198733
[3] GB2030966
[4] U.S. Pat. No. 3,309,451
[5] US2012/012602
[6] US2013/168394
[7] U.S. Pat. No. 5,312,029
[8] U.S. Pat. No. 5,526,953

Acknowledgement of the above references herein is not to be inferred as meaning that these are in any way relevant to the patentability of the presently disclosed subject matter.

### BACKGROUND

Various types of cases, such as suitcases, containers, or any other type of closable receptacle are known in the art. Among these there are examples of injection molded cases with or without locking elements, which may include mechanical latches, snaps and even fasteners which are typically stitched to the edges of the case.

Some examples of injected cases and their portions are describes in references [1]-[8].

### GENERAL DESCRIPTION

The term case as used herein is meant to refer to any article comprising at least one shell and a cover member which can be constituted by another shell, forming together an enclosed compartment when the at least one shell and the cover member are engaged with one another through a fastener. Such a case can be for example a luggage case, a suitcase, a trolley, a tool case, etc.

The term fastener as used herein refers to an engaging member configured to mechanically join or fasten at least two related elements, e.g. a zipper that engages and disengages the at least one shell and the cover member.

The present disclosure is directed to a molded case, typically made of a polymeric material, and in particular to an injection-molded plastic case. In accordance with one aspect of the present disclosure, the case comprises at least one shell formed by injection-molding of a plastic material, the at least one shell being rigid and maintaining its shape, said at least one shell further comprising a rigid functional structure and wherein further comprising an edge defining a perimeter fitted with integrally molded fastener at least over a major portion of the perimeter, the fastener configured to fasten the at least one shell to a complementary cover member so as to define an enclosed space therebetween.

The term rigid is meant to denote an element, e.g. a shell of the case or any other structural element of the case, which is designed to carry a load without deforming. For example, when referring to a rigid shell of the case, the shell is designed for maintaining its integrity and overall shape without deforming, denting, bending, etc. when a mechanical load is applied onto the shell, for example exposed to a mechanical impact.

The case in accordance with an aspect of the disclosed subject matter comprises at least one first shell and a second shell formed by injection molding of a plastic material, the first shell and the second shell each comprising an integrally molded fastener at least over a major portion of a perimeter thereof the fastener configured to fasten the first shell to the second shell so as to define an enclosed space.

In another aspect of the disclosed subject matter, there is disclosed a case comprising a first shell and a second shell comprising a plastic material formed by injection molding of a plastic material, the first shell and the second shell each comprising an integrally molded fastener at least over a major portion of a perimeter thereof, the fastener configured to fasten the first shell to the second shell so as to define an enclosed space and wherein the fastener is configured to allow hinging of the first shell and the second shell with respect to each other and to facilitate closing and opening the articulation between the first shell and the second shell, the configuration being such that no sewing is required to attach the fastener to the shell perimeter.

In yet another aspect, there is provided a method of making a case, the case comprising a first shell and a second shell, the first shell and the second shell each comprising an integrally molded fastener at least over a major portion of a perimeter thereof the fastener configured to fasten the first shell to the second shell so as to define an enclosed space, the method comprising:
(a) inserting and positioning at a pre-designated position a fastener in a mold cavity of an injection mold;
(b) closing the mold and injecting a polymeric material thereby molding at least one of the first shell and the second shell such that the fastener extends along at least over a major portion of a perimeter of the injection molded shell.

Any one of the following embodiments can form part of the disclosed subject matter alone or in combination:
the plastic material comprising strength enhancing material;
the plastic material is reinforced by comprising a textile material;
the plastic material is a composite material;
the plastic material is a layered material obtained by injecting the plastic material in layers in a single molding cycle;
the fastener is configured for expansion and comprises at least two separately operable fasteners;
the fastener is a zipper fastener comprising a support member having a free end and another end integrally formed with a fastening member, and wherein the support member comprises plastic material therein so as to allow for an autogenous bonding of the support member to the perimeter of the shells;
the support member is continuously bonded to the shell at least over a major portion of its perimeter;
the bonding is formed at intervals;
the minimal distance between the bonding points is in the range of 3-5 mm;
at least a portion of the support member is continuously peripherally bonded at its free end, such that about 1-1.5 mm thereof are continuously bonded to the plastic material.
the bonding is non continuous at any desired pattern;
the bonding is visible on one or both sides of the shell perimeter;
at least one pair of wheel assemblies is connected to a socket integrally formed at one end of the at least one of the first shell and the second shell;
at least one pair of wheel assemblies is connected to a socket integrally formed at one end of the at least one of the first shell and the second shell so located as to be positioned at the corners of said case;
one of the first shell and the second shell are configured with two elongated channels extending from one end thereof to the opposite end, such that the elongated channels protrude inwardly facing the enclosed space, the channels being configured to receive a retractable handle; and
at least one part of the injection mold comprises a plurality of movable pins configured to hold in place the fastener during the molding process.

### BRIEF DESCRIPTION OF THE DRAWINGS

In order to better understand the subject matter that is disclosed herein and to exemplify how it may be carried out in practice, embodiments will now be described, by way of non-limiting examples only, with reference to the accompanying drawings, in which:

FIGS. 1A-1E illustrate a luggage case in accordance with an example of the disclosed subject matter and its various portions, such that FIGS. 1A and 1B illustrate the case in a perspective side view, and FIGS. 1C to 1E illustrate enlarged sections of the respective areas of the case fastener marked I on FIG. 1B;

FIGS. 2A and 2B illustrate one shell of the case of FIG. 1A in a top perspective view, with FIG. 2B being an enlarged section of the portion marked II in FIG. 2A;

FIGS. 3A and 3B illustrate the shell of FIG. 2A in a bottom perspective view, with FIG. 3B illustrating an enlarged section of portion marked II of the inner side of the case fastener;

FIGS. 4A to 4C illustrate a wheel bearing area of the suitcase, with FIG. 4B illustrating the socket devoid of the wheel and FIG. 4C illustrating the wheel positioned within the socket;

FIGS. 5A and 5B illustrate a luggage case in accordance with another example of the disclosed subject matter, where FIG. 5A illustrates a back side perspective view and FIG. 5B illustrates the back shell of the case of FIG. 5A;

FIGS. 6A-6C illustrate steps of injection molding of the luggage case in accordance with an example of the disclosed subject matter;

FIGS. 7A and 7B illustrate in a perspective view portions of the molds seen in FIGS. 6A-6C;

FIGS. 8A-8D illustrate in cross section portions of the injection molded case a shell within the mold of FIG. 7; and

FIGS. 9A and 9B illustrate a luggage case from a side view and an opposite side view in accordance with another example of the disclosed subject matter.

### DETAILED DESCRIPTION OF EMBODIMENTS

The disclosed subject matter is directed to a plastic injection-molded case. The case designated 100 comprises at least one first shell 120 and a second shell 140, each formed by injection-molding of a plastic material. The shells 120 and 140 each have a substantially planar base wall 122,142, respectively, and respective circumferentially extending wall 124,144 extending at an angle from the base wall. The circumferentially extending wall 124 is provided with a peripheral portion 125 constituting the edge of shell 120; similarly peripheral portion 145 constitutes the edge of shell 140.

It will be appreciated that although the illustrated example comprises two complementary shells, in other examples the case may include one rigid shell and the other shell being constituted by a cover member which can be made of fabric, a composite material such as fabric covering, or injected, at least partially, with plastic. In another example, the cover member can be a foldable cover member configured to fold and unfold as desired to allow access to the space thereunder.

In some examples, the base wall is a non-planar wall, e.g. a substantially concave wall or a wall having various geometrical shapes. Another example is a clam-like shape wherein the edge of the clam defines the edge of the shell.

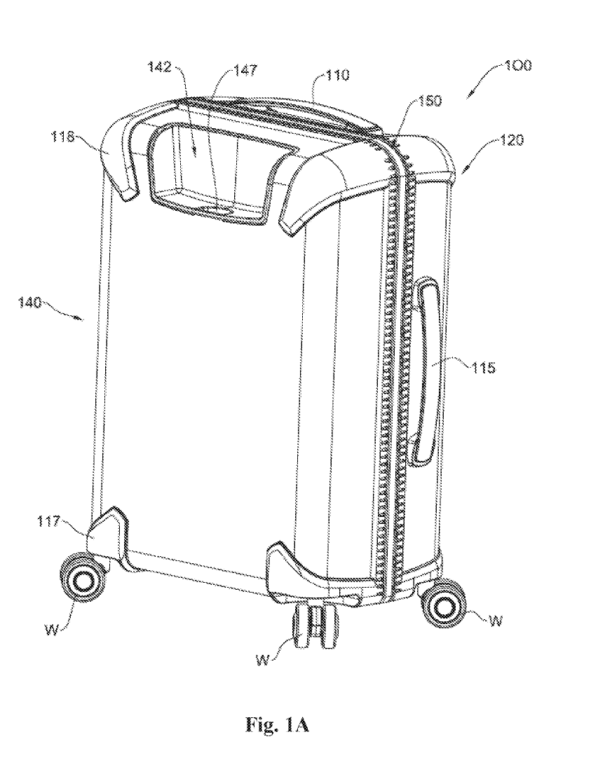

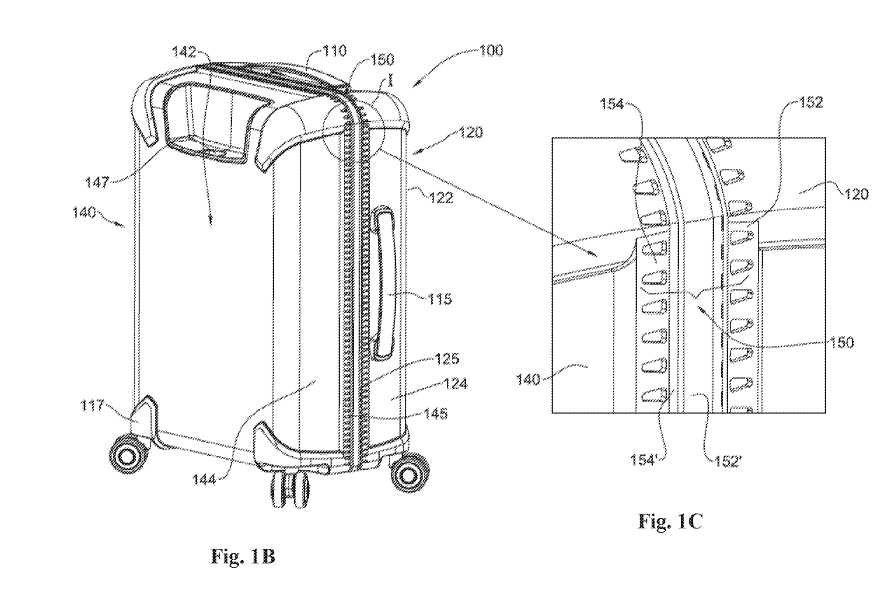

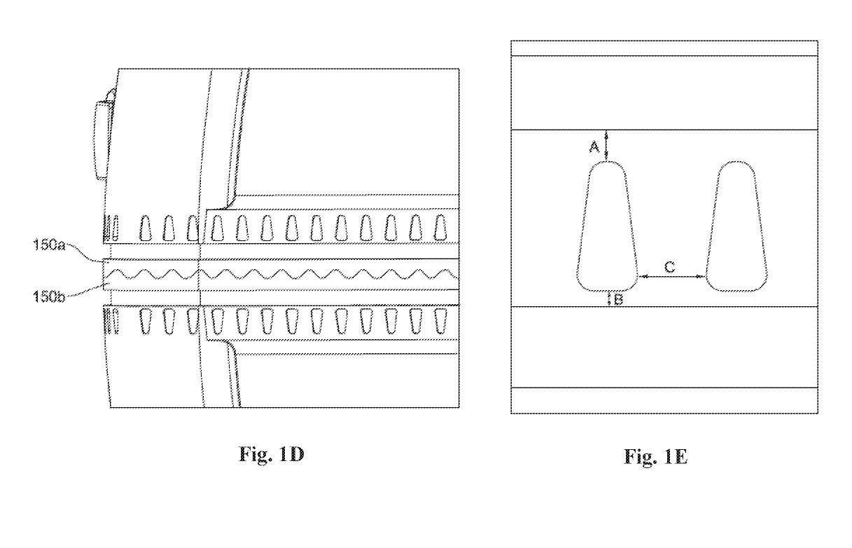

As seen, e.g. in FIG. 1A, the first shell 120 and the second shell 140 each comprise an integrally molded fastener 150 which extends along a major portion of the perimeter of the shells so as to allow fastening of the two shells together and to define an enclosed space.

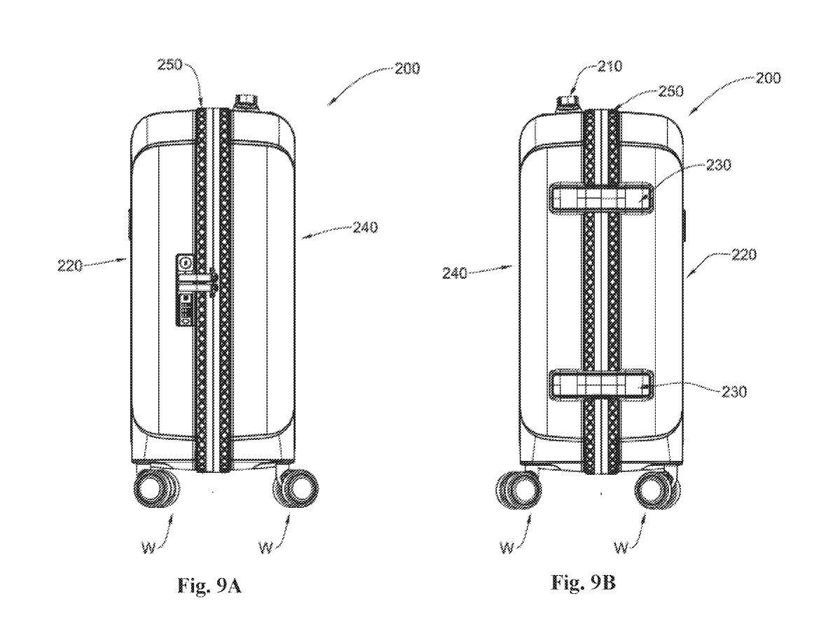

In accordance with this example, the fastener 150 is configured to allow fastening of the first shell 120 and the second shell 140 in a hinged manner with respect to each other and to facilitate closing and opening the articulation between the first shell 120 and the second shell 140. As best seen in FIG. 9B, to control the degree of respective movement of the two shells and so as to prevent disengagement between the first shell and the second shell, there are provided two connecting straps 230 connecting the first shell 220 to the second shell 240. As best seen, e.g. in FIG. 1C, the configuration being such that no stitching or any other means of articulation, such as adhesives, mechanical means of connecting (e.g. screws, nails etc.) are required to attach the fastener to the shell perimeter. This will be further described hereinafter.

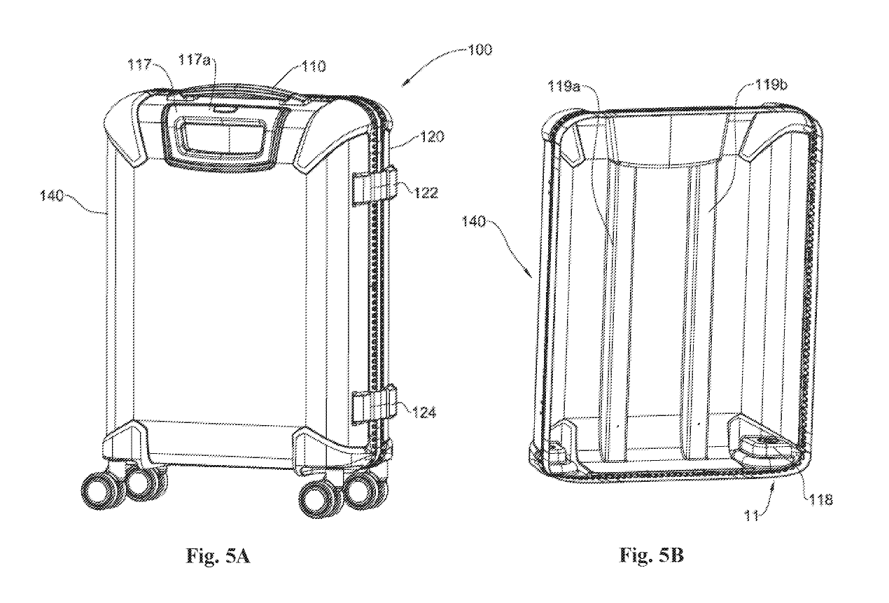

The luggage case 100 further comprises a side handle 115 and a top handle 110. In addition and as best seen in FIG. 5A, the case can further comprise a retractable handle 117 which in this example is telescopically retractable having two elongated arms (not seen) connected to each other by a hand-held portion which in the illustrated example is designed as a trapezoid loop 117a. The two elongated arms are configured to extend within complementary channels 119a and 119b formed in the shell 140, the channels being integrally formed with the shell 140. It will be appreciated that although in the illustrated example the channels are provided as a unitary and continuous plastic molded structure, the channels can further be non-continuous, namely constituted by a plurality of tubular sections configured to hold the elongated arms in place and allow their telescopic movement therewithin. Nevertheless, it will be appreciated that having continuous and unitary channels provides for stability and rigidity to the structure suitable to support the elongated arms and allowing movement of the arms therewithin. The elongated arms can be provided with various securing elements to allow holding the ends thereof within the channels so as to avoid their full retraction out from the channels. The channels as indicated above are an integral part of the shell and are injection-molded with the shell by use of retractable inserts provided in the respective mold. It will be further appreciated that various reinforcing elements can be used to provide rigidity and support to the structure, e.g. if a relatively thin layer is molded in the injection process (e.g. for reducing weight of the final product).

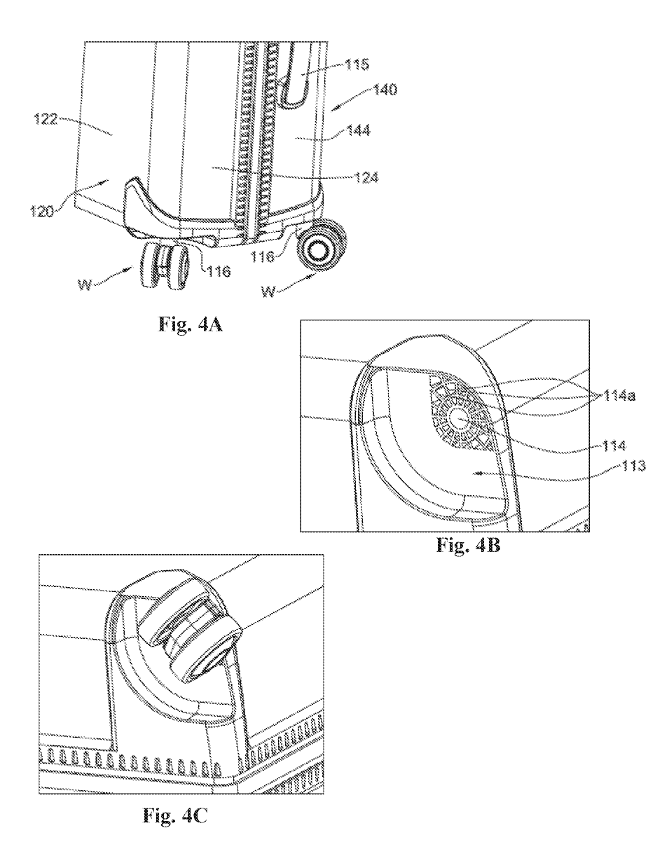

The luggage case is further provided with four wheels W for allowing rolling of the suitcase on a surface. As seen in FIGS. 4B and 4C, the wheels are attached to the case shells 120 and 140 at respective functional structures in a form of a socket 113 configured to engage the wheels W and to allow their rotation thereabout. As such, the sockets 113 are constituted by depressions formed at the bottom corners of the shells. A bore 114 is defined in each socket 113 and is configured to receive a wheel supporting-pin 116 (best seen in FIG. 4A). The bore 114 is a reinforced structure formed by a plurality of integrally molded ribs 114a which extend into the space defined by the shell walls (best seen in FIG. 5A). This extension is of a height sufficient to support the pins 116 in place without the need for any external supports and covers. This reduces the number of elements used for the construction of the case, as well as shortens the assembly time of the final product 100. In the manufacturing process the functional structure for wheel engagement is molded with the shell by using suitable inserts.

It will be appreciated that although the amount of plastic material used to mold the shell is low so as to reduce the weight of the product, at the area of the functional structure, due to the provision of the reinforcing ribs to support the bore and the inwardly extended portion of the structure, the structure is of high resilience and is configured to hold its shape and supports the wheels at rest (with or without the load in the case) as well as during the wheeling motion. It will also be appreciated that although in the illustrated example, the functional structure is not provided with any external support or reinforcement, in accordance with the disclosed subject matter reinforcing elements can be introduced. For example, the socket 113 and/or the bore 114 can be lined with a metal sheet, the extensions can be provided with reinforcing ribs made of a composite material enhancing the strength thereof, the entire structure 113 can comprise reinforcement, e.g. by using elements of composite material.

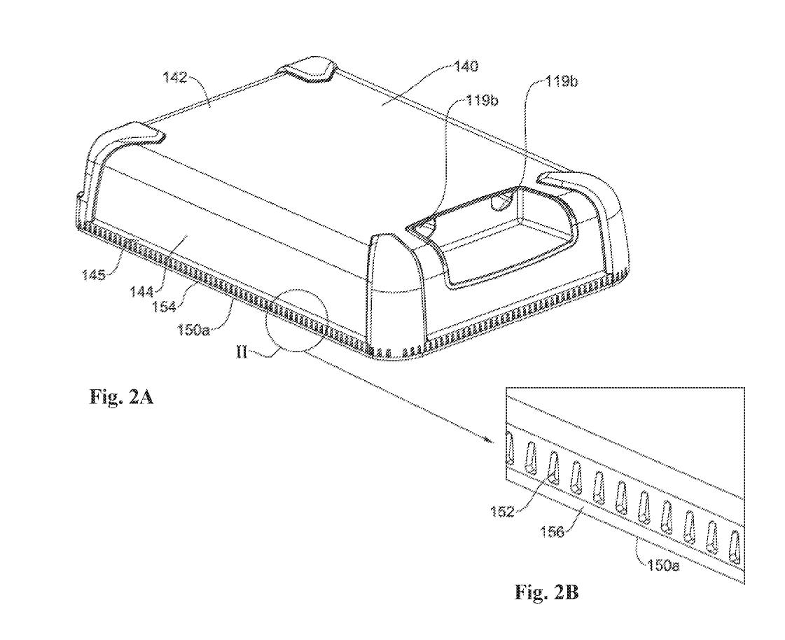

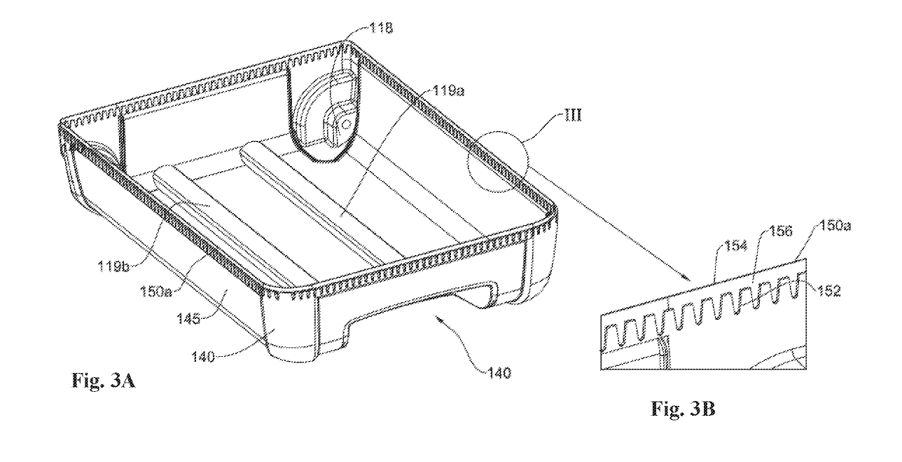

Attention is now directed to the fastener 150 as best seen in FIGS. 2B and 3B. In the illustrated example the fastener is a zipper, however it will be appreciated that the fastener can be any type of fastening structure, e.g. interlocking groove and ridge that form a tight seal when pressed together, overlapping flaps that are sealingly overlapped when tightly placed together following fastening thereof (e.g. as seen in FIGS. 9A and 9B), etc. In accordance with the disclosed subject matter the fastener 150 is respectively provided at the edge of the circumferential wall of each shell 120 and 140. Each part of the fastener 150a and 150b, in this case a zipper type fastener, comprises a support member 152 having a free end (not seen) and another functional end 154 integrally formed with a fastening member 156. The material for the support member 152 is chosen such as to allow for an autogenous bonding of the support member 152 to the perimeter of the shells during the molding process. In the illustrated case, the shells are injection-molded from a thermoplastic material comprising plastic, and the support member 152 of the fastener 150 is chosen to also comprise a plastic material therein. It will be appreciated that although autogenous bonding enhances the bond between the support member 152 and the respective shell perimeter 145, due to the mechanical structure of the bonding as will be further discussed, in some examples the bond can be non-autogenous. In the illustrated example the fastening member is provided substantially along the entire perimeter of the shell although it will be appreciated that other configurations are envisioned (e.g. only part of the periphery holding the fastening member).

FIG. 2B illustrates a portion of the shell 140, perimeter 145, fitted with the fastening member 150a at its periphery. As seen in this illustration, the free end of the support member 152 is embedded within the shell periphery at the depth A (shown in FIG. 1E) and is further mechanically and physically bonded thereto. The bonding is formed at intervals C (seen in FIG. 1E), forming drop-like openings within the peripheral bonding strip 145. The depth A is about 0.8 to 2 mm and in accordance with this example it is about 1-1.5 mm. The intervals are taken at about 2-7 mm and in the illustrated example the range is about 3-5 mm. The inner side of said strip 145 is comprised of a non-continuous strip and in this case the openings are V-like shaped as seen in FIG. 3B. The drop-like openings are characterized by having a continuous edge of the plastic material, which provided for a smooth and continuous ending of the bonding as well as structural enhancement to the periphery of the shell at the location of bonding to the fastener (along substantially the entire fastening member). The width of this strip is marked by B in FIG. 1E. This width B is about 0.8 to 2 mm and in accordance with this example it is about 1-1.5 mm. It will be appreciated that the values for A, B, and C are chosen such as to maintain the required structural rigidity and stability on one hand and on the other to provide for a lightweight structure by minimizing the amount of plastic material used in the molding process. In accordance with an example the minimal distance (C) between the bonding points is in the range of 3-5 mm Values for A and B can vary; in accordance with this example A is about 1-1.5 mm and can be substantially narrower (e.g. shorter than A). Although in this example both sides show the bonding area, it will be appreciated that the periphery can be devoid of any openings at its edge which can be constituted by a continuous edge. Nevertheless, in the present example, the non-continuous bonding provides flexibility to the edge, which will assist in minimizing braking or snapping of the edge and will provide a degree of freedom to the fasteners' support member when the fastener is in use. The pattern of intervals and openings can further vary as will be appreciated by a skilled person and as seen for example in FIGS. 9A and 9B. In accordance with an example of the disclosed subject matter, the peripheral binding strip 145 can be made from a material different from that of the shell, and in certain examples, the material is a thermoplastic material which has properties of higher flexibility and pliability than that of the main shape so as to withstand the forces applied thereon, e.g. when operating the fastening member. Nevertheless, in accordance with this example the strip is injection molded in the same mold as the respective shell member.

Although in the present example a two part fastener is used, it will be appreciated that a fastener configured for expansion can be provided which comprises two or more separately operable fasteners.

Prior to describing the method of molding the shells and the case, it will be noted that the material used for manufacturing the case or portions thereof can be plastic, resinous material, silicone or any other type of polymeric material. It will be further appreciated that the plastic material can be a reinforced plastic material comprising one or more strength enhancing material. It is also envisioned that the plastic material is a reinforced material, combining plastic with an embedded textile material or other type of sheet materials, e.g. PP, PET, PA, POM, PVC, PC and laminates of two or more layers from these or like materials. The plastic material can further be a composite material comprised of two or more different components providing it with the desired strength, flexibility, resilience and rigidity. The plastic material can be enriched with UV protective elements as well as covered by layers of protective substances, color, design, ornamental layers, e.g. patterns etc.

It will be appreciated that the case can be further provided with an inner partition member to divide the case into compartments or to internally cover at least one of the shells. Such a partition member is injection molded separately and is typically, albeit not exclusively, snap-fitted at the shell perimeter to secure it in place. In accordance with one example the partition member comprises a frame member holding therein a web-like sheet, such that the frame is injection molded (i.e. plastic material) over the sheet's perimeter so as to form a stable structure.

In accordance with a particular example, a shell wall can at least partially comprise a layered though unitary structure, e.g. comprising a perforated layer, such as a textile or web of material fibers or woven material sheet and the like, where the plastic layer covers one side of the shell, e.g. the inner side, whilst the opposite side is only selectively covered by plastic. In one example, such a configuration can be achieved by injection-molding the plastic through the perforated layer, and selectively restricting the flow of plastic to the opposite side, such that an inner plastic smooth side is formed with the opposite, external side, being textured. Such a restriction can be controlled by means of an injection mold, e.g. mold having selectively disposed channels which will allow the plastic material to flow thereinto, while the remaining parts of the respective mold (i.e. around the channels) will be pressed firmly against the layer so as to restrict the flow of the molten material. The complementary mold cover can be of a similar structure or as desired, e.g. allowing formation of a plastic layer covering the perforated sheet. Furthermore, in the event that the perforated layer is not used to cover the entire surface of the shell, the mold will be provided with retractable holding pins so as to allow holding the sheet during injection therethrough and retract the same when the remainder of the shell is injected.

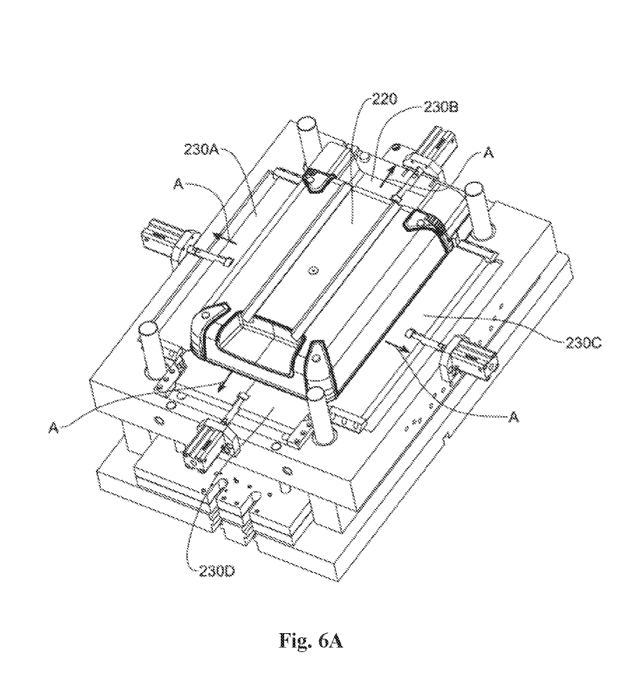

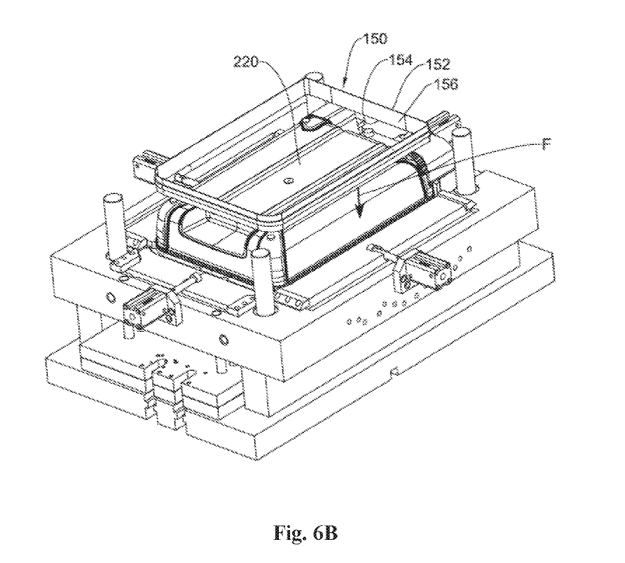

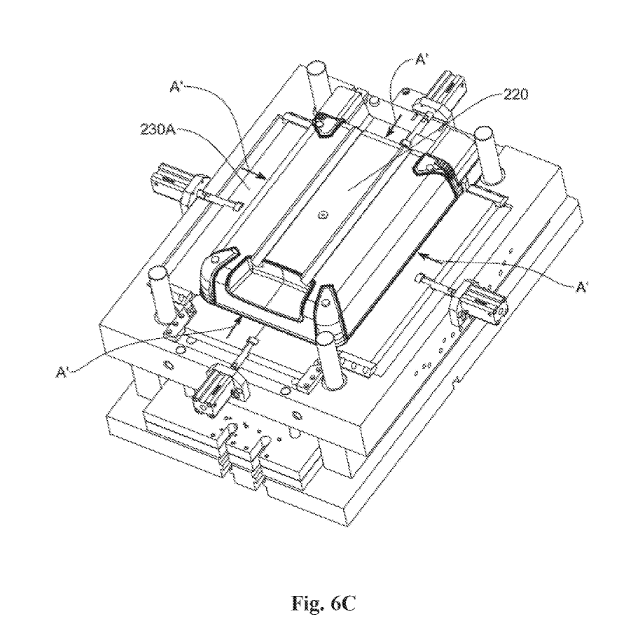

Turning now to FIGS. 6A to 8D, the method of molding the case in accordance with the disclosed subject matter will be described.

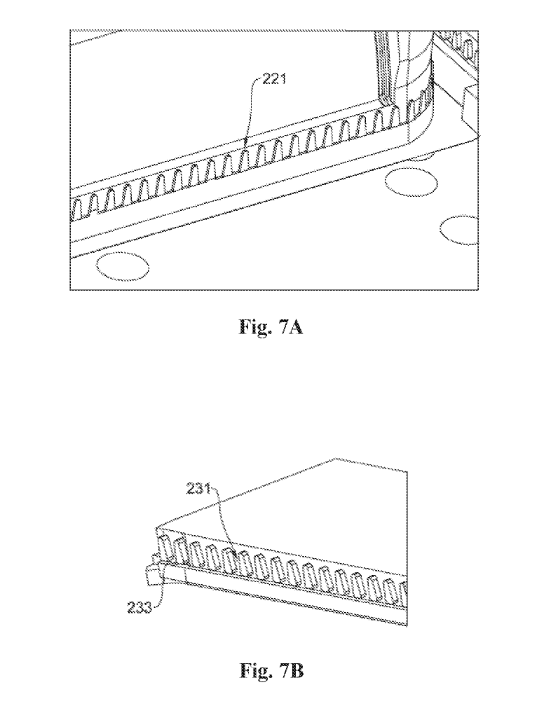

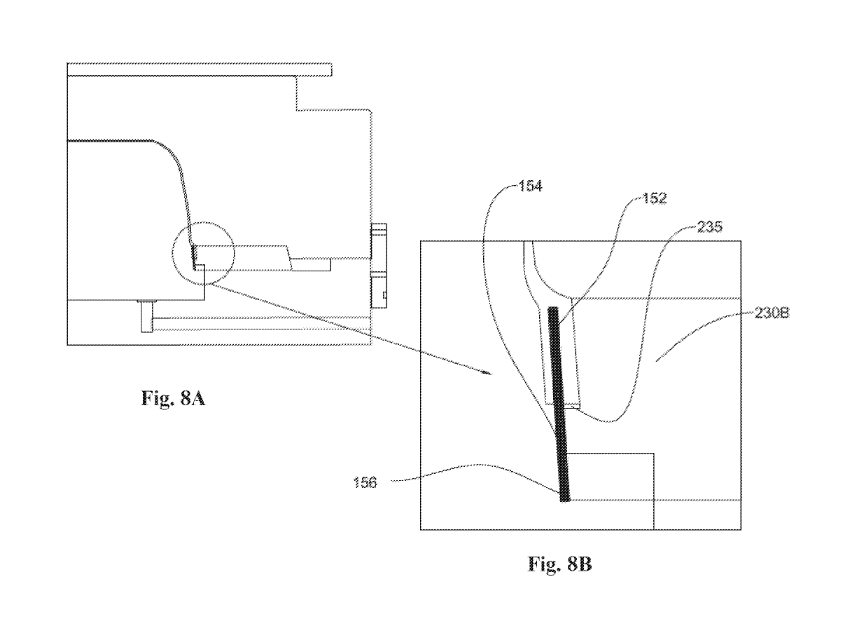

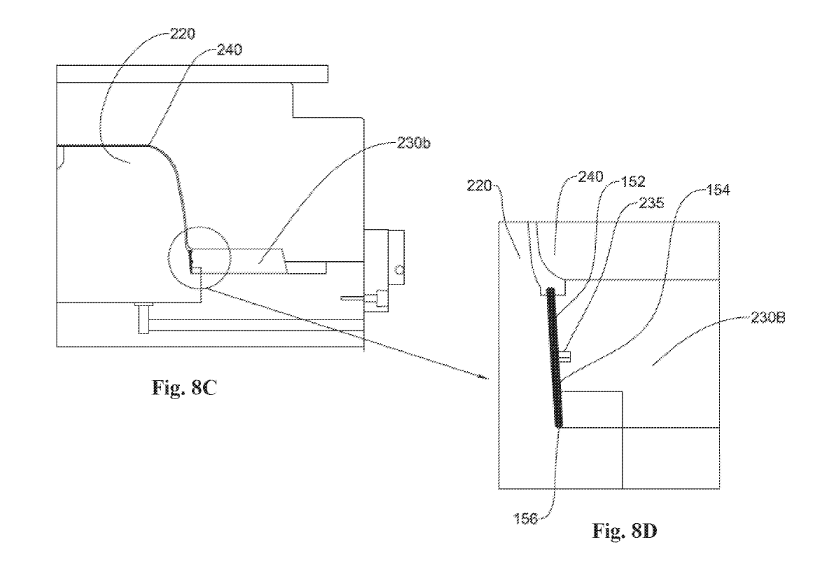

The mold of the disclosed subject matters is provided with a central core member 220 and a mold cavity 240 (seen partially in FIG. 8C) and four peripherally extending sliding cores 230A-230D. These define together the shape of the final object to be injected. As will be noted in FIGS. 6A and 6B, the central core 220 corresponds to the shape of the shell 140. The sliding cores 230A-230D are provided to hold the support member of the fastener in place during injection, and are shaped to facilitate the injection of the peripheral edge. As best seen in FIGS. 7A and 7B, the central core 220 and the sliding cores 230A-230D are provided at their side walls with outwardly protruding clamping members 221 and 231, respectively, which are configured in operation to hold together the support member 152 of the fastener and to allow molten plastic material to flow therearound (as shown in FIG. 8B). As best seen in FIG. 7B and illustrated in operation in FIGS. 8B and 8D, the clamping members hold the support member 152 in place while the plastic is allowed to flow in areas devoid of such elements, thus providing for selective/non-continuous strip that holds the fastener at the shell edge during injection. To prevent flow of the molten material over the fastening element itself (e.g. the zipper teeth) the sliding cores are provided with a flow preventing step member 233, which in operation (as seen in FIG. 8B as well as 8D) forms a boundary edge 235 above the fastening element. Thus, in the final product, as best seen in FIGS. 1E and 3B, openings are formed at the areas where the clamping members are pressed over the support member 152, as discussed herein. It will be appreciated that although in the illustrated examples the edge of the shell extending over the support member 152 is non-continuous, it can be continuously formed, however, the flow preventing step will be necessary to protect the fastening elements. In accordance with another example, the fastening member can be integrally formed with the shell either from the same material of from an additional material allowed to flow into the mold cavity, e.g. when forming a Ziploc type fastener.

The process of molding of the shell (in this case shell 140 although it will be appreciated that similar steps are followed to mold the second shell 120, mutatis mutandis) over the fastener, comprises the following steps:
(a) prior to positioning of the fastener the sliding cores 230A-230D are retracted away from the central core 220 in the direction of arrows A to make way for the fastener 150 to be received (FIG. 6A).
(b) the fastener 150 is then inserted and positioned around the central core 220 at a pre-designated position (FIG. 6B). The fastener in the illustrated example is placed within the gap surrounding the central core 220 and further defined by the retracted sliding cores. The direction of placement of the fastener is identified by the arrow F.
(c) Following the placement of the fastener, the sliding cores are brought together in the direction A′ (seen in FIG. 6C) which is opposite to the direction of arrow A so as to tightly hold the fastener in place. It will be appreciated that the portion held by the clamping members in place is the support member of the fastener, with the functional edge 154 thereof being kept securely exposed under the flow preventing step 233 preventing any injection of the molten material thereover.
(d) The next step is closing the mold and injecting a polymeric material thereby molding at least one of the first shell and the second shell such that the fastener extends along the perimeter of the injection molded shell (FIGS. 8A-8D).

In connection with step (b), it will be appreciated that the placement of the fastener can be performed in various manners, e g manually, by a robotic arm, in an automated manner. In this connection it will be appreciated that the fastening member can be pre-cut to the desired length/shape. In another example, the fastening member can be continuously introduced into the mold and further provided with a cutting element associated therewith to cut the fastening member at the desired length. It will be appreciate that although the description is referring to the injection molding of the shells in a separate manner, in accordance with an example of the disclosed subject matter the first shell and the second shell can be molded side by side and in a simultaneous manner such that the fastening member can be simultaneously introduced to both shells, thus maintaining the position of the fastening elements (e.g. the respective zipper teeth).

When the first shell and the second shell are simultaneously molded, it will be appreciated that the time of manufacturing of the final product is substantially reduced, resulting in that the case is manufactured in an essentially single molding cycle. To finish the product, there can be added as desired handles, the wheels, and any associated accessories, e.g. inner cover layer to cover the inner surface of the shells, a partition member etc.

1.-22. (canceled)

23. A case, comprising:
at least one substantially rigid shell formed by injection-molding of a plastic material, the shell having a rigid structural component, a base panel and a wall circumferentially extending therefrom, the wall having an edge that defines a perimeter of the wall, the perimeter being fitted with molded flexible fastener integrated with at least a portion of said perimeter, the fastener configured to fasten the at least one shell to a complementary cover member so as to define an enclosed space therebetween.

24. The case of claim 23, wherein the rigid structural component may be selected from one or more of at least two reinforced corners; at least one pair of sockets integrally formed at one end of the at least one shell; and at least one elongated channel extending substantially from one end thereof to the opposite end, such that the elongated channel protrudes inwardly facing the enclosed space, the channel being configured to receive a retractable handle.

25. The case of claim 23, wherein the complementary cover member is a complementary shell member.

26. The case of claim 23, wherein the plastic material comprises strength enhancing material.

27. The case of claim 23, wherein the shells are reinforced by a textile material forming an integral part of the shell.

28. The case of claim 23, wherein the shell is formed by a plastic material which is a composite material.

29. The case of claim 23, wherein the shell is formed a composite material constituted by layers of plastic materials.

30. The case of claim 23, wherein the fastener is configured for expansion and comprises at least two separately operable fasteners.

31. The case of claim 23, wherein the fastener is an injection-molded zipper fastener integrally formed with said perimeters.

32. The case of claim 31, wherein said zipper comprises a support member having a free end, and another end integrally formed with a fastening member, and wherein the support member comprises elements of plastic material therein so as to allow for an autogenous bonding of the support member to the perimeter of the shells.

33. The case of claim 32, wherein (i) the support member is continuously bonded to the shell at least over a major portion of its perimeter, or (ii) wherein the bonding is formed at intervals.

34. The case of claim 32, wherein the bonding is non-continuous at any desired pattern.

35. The case of claim 32, wherein the bonding is visible on one or both sides of the shell perimeter.

36. The case of claim 23, further comprising at least one pair of wheel assemblies connected to a socket integrally formed at one end of the at least one of the first shell and the second shell.

37. The case of claim 23, further comprising at least one pair of wheel assemblies connected to a socket integrally formed at one end of the at least one of the first shell and the second shell so located as to be positioned at the corners of said case.

38. The case of claim 23, wherein one of the first shell and the second shell are configured with two elongated channels extending from one end thereof to the opposite end, such that the elongated channels protrude inwardly facing the enclosed space, the channels being configured to receive a retractable handle.

39. A method of making a case, the case comprising a first shell and a second shell, the first shell and the second shell each comprising an integrally molded fastener at least over a major portion of a perimeter of the shell, the fastener configured to fasten the first shell to the second shell so as to define an enclosed space, the method comprising:
(a) inserting and positioning at a pre-designated position a fastener in a mold cavity of an injection mold for each one of the first shell and the second shell;
(b) closing the mold and injecting a polymeric material thereby molding at least one of the first shell and the second shell such that the fastener extends along at least over a major portion of a perimeter of the injection molded shell.

40. The method of claim 39, wherein at least one part of the injection mold comprises a plurality of movable pins configured to hold in place the fastener during the molding process.

41. A case comprising a first shell and a second shell, the first and second shells being rigid and formed by injection-molding of a plastic material,
the first shell and the second shell each comprising a flexible fastener integrally molded with at least a major portion of a perimeter of the shells, the fastener configured to fasten the first shell to the second shell so as to define an enclosed space, and
wherein the fastener is configured to allow hinging of the first shell and the second shell with respect to one another and to facilitate closing and opening the fastened articulation between the first shell and the second shell, the configuration being such that no mechanical, chemical or physical articulation elements are required to attach the fastener to the shell perimeter.
